(19) United States
(12) Patent Application Publication
(10) Pub. No.: US 2026/0018139 A1
(43) Pub. Date: Jan. 15, 2026

(54) DISPLAY DEVICE

(71) Applicant: Samsung Display Co., Ltd., Yongin-si (KR)

(72) Inventors: Ki Ho LIM, Yongin-si (KR); Dae Won KIM, Yongin-si (KR)

(21) Appl. No.: 19/205,702

(22) Filed: May 12, 2025

(30) Foreign Application Priority Data
Jul. 12, 2024 (KR) 10-2024-0092285

(51) Int. Cl. G09G 3/3275

(52) U.S. Cl. CPC G09G 3/3275; G09G 2310/08; G09G 2320/0271; G09G 2320/0666; G09G 2380/02

(57) ABSTRACT

The present disclosure relates to a display device. According to one or more embodiments of the disclosure, a display device comprising a display panel comprising a display area where pixels are arranged, a data driver configured to provide data signals to the pixels of the display panel, and a main driver configured to correct image data from outside based on structural deformation amount of a folding area of the display area to provide it to the data driver, and to control driving timing of the data driver, wherein the main driver is configured to divide the display area into at least one folding area and first display area and the second flat display area, corrects the image data based on the structural deformation amount of the folding area, and aligns corrected image data to provide it to the data driver.

### CROSS-REFERENCE TO RELATED APPLICATION

The present application claims priority to, and the benefit of, Korean Patent Application No. 10-2024-0092285, filed on Jul. 12, 2024, in the Korean Intellectual Property Office, the entire disclosure of which is incorporated herein by reference.

### BACKGROUND

### 1. Field

The present disclosure relates to a display device.

### 2. Description of the Related Art

As the information-oriented society evolves, various demands for display devices are ever increasing. For example, display devices are being employed by a variety of electronic devices, such as smart phones, digital cameras, laptop computers, navigation devices, and smart televisions.

Display devices may be flat panel display devices, such as a liquid-crystal display device, a field emission display device, and an organic light-emitting display device. Among such flat panel display devices, an organic light-emitting display device includes a light-emitting element that can emit light on its own, so that each of the pixels of the display panel can emit light by themselves. Accordingly, a light-emitting display device can display images without a backlight unit that supplies light to the display panel.

Recently, various types of display devices that can selectively adjust the image display area, unlike simple flat display devices, have been developed. For example, various types of flexible display devices, such as foldable display devices, rollable display devices, bendable display devices, curved display devices and stretchable display devices, are under development.

### SUMMARY

Aspects of the present disclosure provide a display device capable of reducing or preventing degradation of image quality, such as degradation of visibility, at a folding area and folding peripheral areas of a variety of flexible display devices, such as foldable and rollable display devices.

Aspects of the present disclosure provide a display device that can reduce or prevent degradation of image quality caused by structurally deformed image display areas by way of employing data correction processing technology based on structural deformation, such as creases in a folding area and folding peripheral areas.

It should be noted that aspects of the present disclosure are not limited to the above, and other aspects of the present disclosure will be apparent to those skilled in the art from the following descriptions.

According to one or more embodiments of the disclosure, a display device includes a display panel including pixels in a display area having a folding area, a data driver configured to provide data signals to the pixels, and a main driver configured to correct image data based on a structural deformation amount of the folding area, provide the corrected image data to the data driver, control driving timing of the data driver, divide the display area into the folding area, a first flat display area, and a second flat display area, align the image data, and provide the image data to the data driver.

The main driver may be further configured to divide the display area into the folding area, a first folding peripheral area, a second folding peripheral area, the first flat display area, and the second flat display area, and generate the corrected image data by correcting the image data corresponding to at least one of the folding area, the first folding peripheral area, the second folding peripheral area, the first flat display area, or the second flat display area based on the structural deformation amount of the folding area, the first folding peripheral area, or the second folding peripheral area.

The main driver may include a block data aligner configured to divide the display area into the folding area, the first folding peripheral area, the second folding peripheral area, the first flat display area, and the second flat display area, and configured to divide and align the corrected image data at least every frame into block data, a deformation calculator configured to count a number of folding times and folding duration of the display panel, and configured to calculate structural deformation amount information for the folding area, the first folding peripheral area, or the second folding peripheral area, a compensation data detector configured to detect compensation data corresponding to the structural deformation amount information, and a data corrector configured to calculate, using a calculation formula, the block data according to the folding area, the first folding peripheral area, the second folding peripheral area, the first flat display area, and the second flat display area with the compensation data, and configured to generate the image data.

The main driver may further include a frame data aligner configured to align the image data at least every frame, and configured to provide the image data to the block data aligner, a compensation data storage configured to store the compensation data according to the structural deformation amount as one or more experimental values, an image display checker configured to check whether an image is displayed in a folding state, and configured to output an image display signal or an image non-display signal, and a correction data aligner configured to combine the corrected image data to generate, and configured to output the corrected image data at least every frame.

The block data aligner may be configured to divide the display area into the folding area, the first folding peripheral area, the second folding peripheral area, the first flat display area, and the second flat display area, according to area information.

The deformation calculator may be configured to count the number of the folding times and the folding duration, is configured to calculate the structural deformation amount information based on the number of the folding times and the folding duration, and is configured to provide the structural deformation amount information to the compensation data detector.

The compensation data may correspond to the structural deformation amount information, wherein the compensation data includes compensation grayscale values or compensation luminance values for the folding area, the first folding peripheral area, the second folding peripheral area, the first flat display area, or the second flat display area.

The compensation grayscale values or the compensation luminance values are stored in a gradually variable form proportional to the structural deformation amount.

When an image is displayed in a folding state of the display panel, the compensation data detector may be configured to detect the compensation data according to the structural deformation amount information calculated by the deformation calculator, and is configured to provide the compensation data to the data corrector, wherein the data corrector is configured to calculate the compensation data with the block data using the calculation formula, and is configured to generate the corrected image data.

When an image is not displayed in a folding state of the display panel, the compensation data detector may be configured to detect the compensation data according to the structural deformation amount information calculated by the deformation calculator, and is configured to provide the compensation data to the data corrector, wherein the data corrector is configured to calculate the block data with the compensation data using the calculation formula, and is configured to generate the corrected image data.

The main driver may further include a luminance/color temperature data input configured to detect luminance information or color temperature information of the display panel using a luminance sensor, and is configured to generate luminance data or color temperature data corresponding to the luminance information or the color temperature information, and a compensation data modulator configured to extract an offset value inversely proportional to the luminance information or the color temperature information, and configured to modulate the compensation data using the offset value.

The compensation data modulator may be configured to extract the offset value that is inversely proportional to the luminance information, and is configured to modulate the compensation data by calculating the compensation data with the offset value using a calculation formula.

When an image is displayed in a folding state of the display panel, the compensation data modulator may be configured to calculate the compensation data modulated by the compensation data modulator with the block data by the calculation formula, wherein, when no image is displayed in the folding state of the display panel, the compensation data modulator is configured to calculate the modulated compensation data with the block data using the calculation formula.

According to one or more embodiments of the present disclosure, a display device includes a display panel including pixels in a display area having a folding area, a data driver configured to provide data signals to the pixels, a gate driver configured to provide gate signals to the pixels, a touch sensor on a front surface of the display panel for detecting a user touch, a touch driver configured to detect a touch position and a touch movement position for a touch-sensing area of the touch sensor, and configured to generate touch coordinate data, and a main driver configured to control driving timing of the data driver, divide the display area into the folding area, a first folding peripheral area, a second folding peripheral area, a first flat display area, and a second flat display area, generate corrected image data by correcting externally supplied image data corresponding to at least one of the folding area, the first folding peripheral area, the second folding peripheral area, the first flat display area, or the second flat display area according to a structural deformation amount of the folding area, the first folding peripheral area, or the second folding peripheral area, and provide the corrected image data to the data driver.

The main driver may include a block data aligner configured to divide the image data at least every frame into block data according to the folding area, the first folding peripheral area, the second folding peripheral area, the first flat display area, and the second flat display area to align the block data, a deformation calculator configured to count a number of folding times and folding duration of the display panel, and configured to calculate structural deformation amount information for the folding area, the first folding peripheral area, and the second folding peripheral area, a compensation data detector configured to detect compensation data corresponding to the structural deformation amount information, and a data corrector configured to calculate, using a calculation formula, the block data with the compensation data to generate the corrected image data.

According to one or more embodiments of the disclosure, an electronic device includes a display device, the display device including a display panel including pixels in a display area having a folding area, a data driver configured to provide data signals to the pixels, and a main driver configured to correct image data based on a structural deformation amount of the folding area, provide the corrected image data to the data driver, control driving timing of the data driver, divide the display area into the folding area, a first flat display area, and a second flat display area, align the image data, and provide the image data to the data driver.

According to embodiments of the present disclosure, it is possible to reduce or prevent degradation of image quality, such as degradation of visibility, in a folding area and folding peripheral areas in a flexible display device, such as foldable and rollable display devices.

In addition, according to embodiments of the present disclosure, it is possible to reduce or prevent degradation of image quality caused by structurally deformed image display areas of a display device by way of employing data correction processing technology based on structural deformation, such as creases in a folding area and folding peripheral areas, and it is possible to increase user reliability and satisfaction.

It should be noted that aspects of the present disclosure are not limited to those described above and other aspects of the present disclosure will be apparent to those skilled in the art from the following descriptions.

### BRIEF DESCRIPTION OF THE DRAWINGS

The above and other aspects of the present disclosure will become more apparent by describing in detail embodiments thereof with reference to the attached drawings, in which:

FIG. 1 is a perspective view showing a foldable, portable display device according to one or more embodiments of the present disclosure.

FIG. 2 is a plan view showing the configuration of a foldable display device according to one or more embodiments of the present disclosure.

FIG. 3 is a cross-sectional view showing one side of the foldable display device shown in FIG. 2 in detail.

FIG. 4 is a view showing an example of a layout of a display panel according to one or more embodiments of the present disclosure.

FIG. 5 is a block diagram showing in detail a main driver according to first one or more embodiments.

FIG. 6 is a view showing a folding area, folding peripheral areas, and flat display areas divided in a display area according to one or more embodiments of the present disclosure.

FIG. 7 is a view showing experimental results of crease deformation in the folding area over the number of folding times and folding duration.

FIG. 8 is a graph showing change in the grayscale value of corrected data applied to image data of the folding area versus the amount of crease deformation in the folding area.

FIG. 9 is a view showing an example in which an image is displayed in the folding area, the folding peripheral areas, and the flat display areas in a flat state.

FIG. 10 is a view showing an example in which an image is not displayed in the folding area, the folding peripheral areas, and the flat display areas in the flat state.

FIG. 11 is a graph showing change in the grayscale value of corrected data applied to image data of a flat display area versus the amount of crease deformation in the folding area.

FIG. 12 is a block diagram showing in detail a main driver according to second one or more embodiments.

FIG. 13 is a graph showing change in the offset value applied to the compensation data versus change in external luminance or color temperature.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

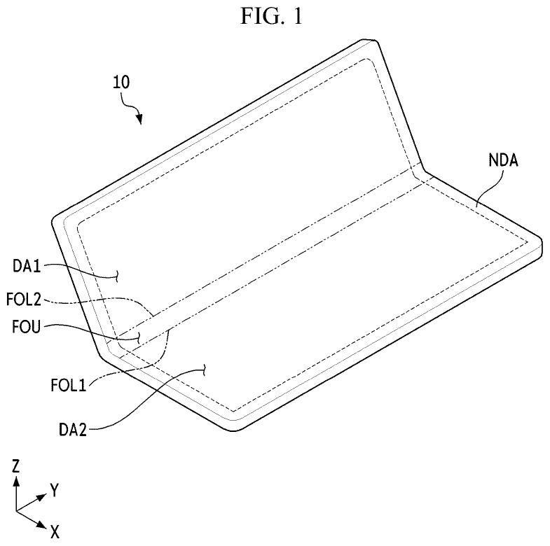

FIG. 1 is a perspective view showing a foldable, portable display device according to one or more embodiments of the present disclosure.

Referring to FIG. 1, a portable display device according to one or more embodiments of the present disclosure (e.g., display device 10) may be employed by portable electronic devices, such as a mobile phone, a smart phone, a tablet PC, a mobile communications terminal, an electronic notebook, an electronic book, a portable multimedia player (PMP), a navigation device and a ultra mobile PC (UMPC), as a foldable display device. Alternatively, the display device 10 according to embodiments of the present disclosure may be used as a display unit of a television, a laptop computer, a monitor, an electronic billboard, or the Internet of Things (IOT).

As used herein, the first direction (x-axis direction) may be the shorter side direction of the display device 10 when the display device 10 is folded, for example, the horizontal direction of the display device 10. The second direction (y-axis direction) may be the longer side direction of the display device 10 when the display device 10 is folded, for example, the vertical direction of the display device 10. A third direction (z-axis direction) may refer to the thickness direction of the display device 10.

In the example shown in FIG. 1, the display device 10 is a foldable display device that can be folded once in the first direction (x-axis direction). The display device 10 may be transformed into between a folding state in which the display device 10 is folded once, a flexed state in which the display device 10 is bent at an angle (e.g., predetermined angle), and a flat state in which the display device 10 is fully unfolded, or may be held in one of the states.

The display device 10 may be folded inwardly such that the front surface where images are displayed is located inside (in-folding manner). When the display device 10 is bent or folded in the in-folding manner, a part of the front surface of the display device 10 may face the other part of the front surface. Alternatively, the display device 10 may be folded outward such that the front surface where images are displayed is located outside (out-folding manner). When the display device 10 is bent or folded in the out-folding manner, a part of the rear surface of the display device 10 may face the other part of the rear surface.

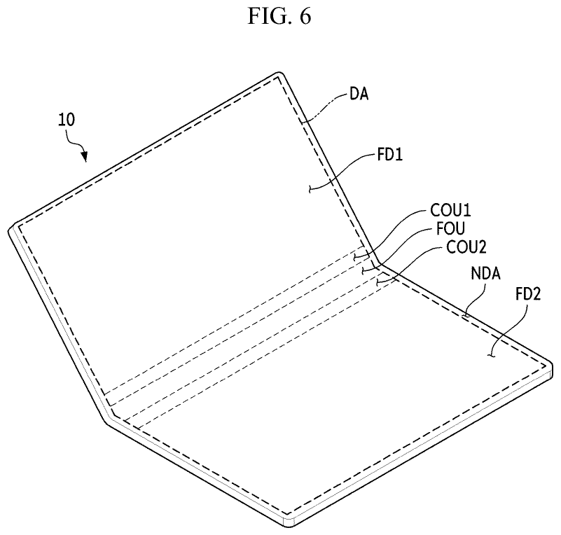

For example, an image display area DA on the front side of the in-folding display device 10 may be divided into first and second flat display areas DA1 and DA2, first and second folding peripheral areas (e.g., see folding peripheral areas COU1 and COU2 in FIG. 6), and a folding area FOU. Therefore, when the display device 10 is unfolded as in FIG. 1, images may be displayed on the front side in the first and second flat display areas DA1 and DA2, the first and second folding peripheral areas, and the folding area FOU of the display device 10.

The image display area (hereinafter referred to as the display area DA) of the display device 10 may be divided into first and second flat display areas DA1 and DA2, at least one folding area FOU and the peripheral areas (e.g., folding peripheral areas COU1 and/or COU2) of the folding area FOU. For example, the folding area FOU may be located between the first and second flat display areas DA1 and DA2, and areas between the sides of the folding area FOU and the first and second flat display areas DA1 and DA2 may become the peripheral areas of the folding area FOU. The arrangement relationships of at least one folding area FOU, the peripheral areas of the folding area FOU, and the first and second flat display areas DA1 and DA2 will be described in more detail later with reference to the accompanying drawings.

A non-display area NDA may be formed at the border of the display area DA, that is, at the borders of the at least one folding area FOU, the peripheral areas of the folding area FOU, and the first and second flat display areas DA1 and DA2.

The at least one folding area FOU may be located between the first and second flat folding areas DA1 and DA2 and between first and second folding peripheral areas and extended in the second direction (y-axis direction), and may be folded inwardly or outwardly in the first direction (x-axis direction).

The first flat display area DA1 may be located on one side of the folding area FOU and the first folding peripheral area, for example, on the right side of the first folding peripheral area. The second flat display area DA2 may be located on the opposite side of the folding area FOU and the second folding peripheral area, for example, on the left side of the second folding peripheral area.

The folding area FOU and first and second folding lines FOL1 and FOL2, which are the boundaries of the folding area FOU may extend in the second direction (y-axis direction), and the display device 10 may be folded in the first direction (x-axis direction).

When the folding area FOU is folded inward, the front surfaces of the first and second flat display areas DA1 and DA2 may face each other. As such, when the folding area FOU is extended in the second direction (y-axis direction) and is folded inwardly or outwardly in the first direction (x-axis direction), the width of the display device 10 in the first direction (x-axis direction) may be reduced to approximately half.

When the folding area FOU and the first and second folding lines FOL1 and FOL2, which are the boundaries of the folding area FOU, are located in the first direction (x-axis direction) so that they extend in the second direction (y-axis direction), the width of the folding area FOU in the first direction (x-axis direction) may be smaller or narrower than the length in the second direction (y-axis direction). In addition, the width of the first flat display area DA1 in the first direction (x-axis direction) may be larger than the width of the folding area FOU and the first folding peripheral area in the first direction (x-axis direction). The width of the second flat display area DA2 in the first direction (x-axis direction) may be larger than the width of the folding area FOU and the second folding peripheral area in the first direction (x-axis direction).

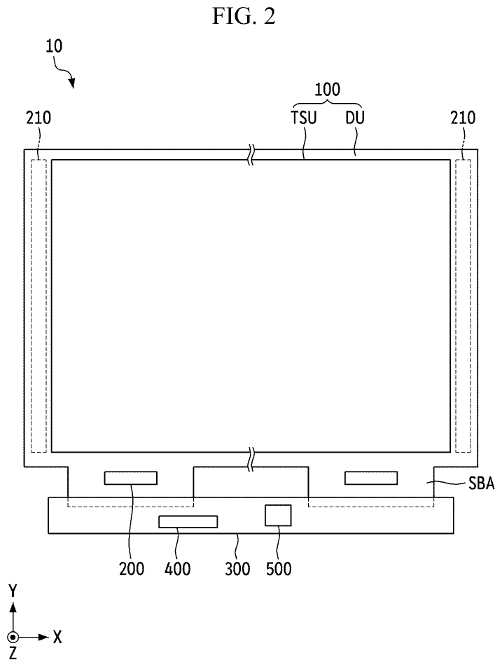

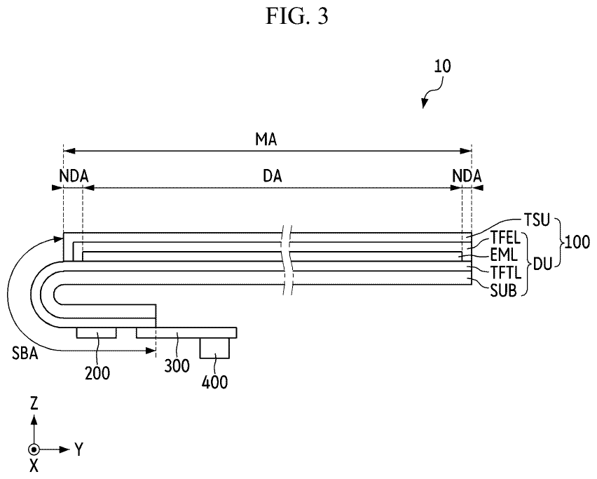

FIG. 2 is a plan view showing the configuration of a foldable display device according to one or more embodiments of the present disclosure. FIG. 3 is a cross-sectional view showing one side of the foldable display device shown in FIG. 2 in detail.

Referring to FIGS. 2 and 3, a display device 10 may be sorted into a variety of devices depending on the way how images are displayed. For example, the display device 10 may be classified into and implemented as an organic light-emitting display device (OLED), an inorganic light-emitting display device (inorganic EL), a quantum-dot light-emitting display device (QED), a micro LED display device (micro-LED), a nano LED display device (nano-LED), a plasma display device (PDP), a field emission display device (FED), a liquid-crystal display device (LCD), an electrophoretic display device (EPD), etc. In the following description, an organic light-emitting display device (OLED) will be described as an example of the display device. The organic light-emitting display device OLED will be simply referred to as the display device 10 unless it is suitable to distinguish between them. It is, however, to be understood that the embodiments of the present disclosure are not limited to the organic light-emitting display device (OLED), and one of the above-listed display devices or any other display device well known in the art may be employed as the display device 10 without departing from the scope of the present disclosure.

As shown in FIGS. 2 and 3, the display panel 100 of the display device 10 includes a display (e.g., image display unit) DU, a plurality of data drivers (e.g., data driver circuits) 200, a circuit board 300, a main driver (e.g., main driver circuit) 400, and a touch-sensing module.

The touch-sensing module may include a touch sensor (e.g., touch-sensing unit) TSU located on the front surface of the display panel 100, and at least one touch driver (e.g., touch driver circuit) 500 that generates touch coordinate data of the touch sensor TSU.

The display DU of the display panel 100 may include a plurality of pixels (e.g., image display pixels). Images may be displayed through the plurality of pixels. Each pixel may include red, green, and blue pixels, or red, green, blue, and white pixels.

The display DU receives data signals (e.g., analog data voltages) from each of the data drivers 200, and gate signals from the main driver 400 (e.g., a gate driver). In addition, the display DU may display images through a plurality of sub-pixels SP arranged in the display area DA of the display DU in response to the data and gate signals.

The display panel 100 may be divided into a main area MA and a subsidiary area SBA. The main area MA may include the first and second flat display areas DA1 and DA2, the first and second folding peripheral areas, the folding area FOU, and the non-display area NDA. Images are displayed through the pixels in the first and second flat display areas DA1 and DA2, the first and second folding peripheral areas, and the folding area FOU.

The subsidiary area SBA may extend from one side of the main area MA. The subsidiary area SUB may include a flexible material that can be bent, folded, or rolled. For example, when the subsidiary area SBA is bent, the subsidiary area SBA may overlap the main area MA in the thickness direction (z-axis direction). The subsidiary area SBA may include pads connected to the main driver 400 and the circuit board 300. Optionally, in one or more embodiments, the subsidiary area SBA may be eliminated, and the main driver 400 and the pads may be located in the non-display area NDA.

The circuit board 300 may be attached on the pad area of the display panel 100 using an anisotropic conductive film (ACF). Lead lines of the circuit board 300 may be electrically connected to the pads of the display panel 300. The circuit board 300 may be a flexible printed circuit board (FPCB), a printed circuit board (PCB), or a flexible film, such as a chip-on-film (COF).

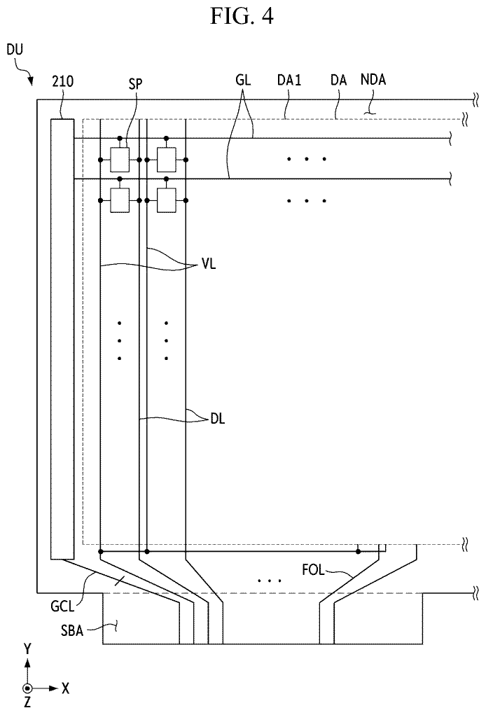

Incidentally, the substrate SUB of the display panel 100 shown in FIG. 4 may be a base substrate or a base member. The substrate SUB may be of a flat type. Alternatively, the substrate SUB may be a flexible substrate that can be bent, folded, or rolled. For example, the substrate SUB may include, but is not limited to, a glass material or a metal material. As another example, the substrate SUB may include a polymer resin, such as polyimide PI.

The thin-film transistor layer TFTL may be located on the substrate SUB. The thin-film transistor layer TFTL may include a plurality of thin-film transistors forming pixel circuits of the pixels. The thin-film transistor layer TFTL may include gate lines, data lines, voltage lines, gate control lines, fan-out lines for connecting the data driver 200 with the data lines, and lead lines for connecting the data driver 200 with the pads. When the gate driver 210 is formed on one side and the opposite side of the non-display area NDA of the display panel 100, each gate driver 210 may also include thin-film transistors.

The thin-film transistor layer TFTL may be selectively located in the image display area DA, the non-display area NDA, and the subsidiary area SBA. The thin-film transistors in each of the pixels, the gate lines, the data lines, and the voltage lines in the thin-film transistor layer TFTL may be located in the image display area DA. The gate control lines and the fan-out lines in the thin-film transistor layer TFTL may be located in the non-display area NDA. The lead lines of the thin-film transistor layer TFTL may be located in the subsidiary area SBA.

The emission material layer EML may be located on the thin-film transistor layer TFTL. The emission material layer EML may include a plurality of light-emitting elements in each of which a first electrode, an emissive layer, and a second electrode are stacked on one another sequentially to emit light, and a pixel-defining layer for defining the pixels. Light-emitting elements of the emission material layer EML may be located entirely in the display area DA.

An encapsulation layer TFEL may cover the upper and side surfaces of the emission material layer EML, and can protect the emission material layer EML. The encapsulation layer TFEL may include at least one inorganic layer and at least one organic layer for encapsulating the emission material layer EML.

The touch sensor TSU may be located on the encapsulation layer TFEL of the display panel 100. The touch-sensing areas of the touch sensor TSU may include a plurality of touch electrodes for sensing a user's touch by capacitive sensing, and touch-driving lines connecting the plurality of touch electrodes with at least one touch driver 400. In each of the touch-sensing areas, touch electrodes may be arranged in a matrix to sense a user's touch by self-capacitance sensing or mutual capacitance sensing.

The touch sensor TSU might not be formed integrally with the display panel 100, but instead may be located on a separate substrate or film located on the display DU of the display panel 100. In such case, the substrate of the film supporting the touch sensor TSU may be a base member encapsulating the display DU.

The touch driver 500 that generates touch coordinate data on the touch-sensing areas may be located in the non-display area NDA or subsidiary area SBA of the display panel 100. Alternatively, the touch driver 500 that generates the touch coordinate data may be mounted on a separate circuit board 300. The touch driver 500 may be implemented as an integrated circuit (IC).

The touch driver 500 may be implemented as at least one microprocessor that is electrically connected to the touch sensor TSU (e.g., touch-sensing areas). The touch driver 500 may supply touch-driving signals to a plurality of touch electrodes arranged in a matrix in the touch sensor TSU and may sense a change in the capacitance between the plurality of touch electrodes. The touch driver 500 may determine whether a user's touch is input and may produce the touch coordinate data based on the amount of the change in the capacitance between the touch electrodes.

The data drivers 200 may be implemented as integrated circuits (IC) and may be located on the respective printed circuit films by the chip-on-glass (COG) technique, the chip-on-plastic (COP) technique, or ultrasonic bonding. The data drivers 200 may convert digital image data into analog data signals in response to a data control signal from the main driver 400, and may provide the data signals to the pixels. The data drivers 200 may provide data signals to the data lines connected to the pixels.

The main driver 400 may be implemented as an integrated circuit and may be mounted on the display panel 100 or on the circuit board 300 by the COG technique, the COP technique, or ultrasonic bonding. The main driver 400 calculates as a main processor and outputs gate and data control signals for driving the pixels of the display DU (e.g., for controlling the drive timing/driving timing of the data driver 200).

In addition, the main driver 400 divides the image display area DA where images are displayed into the first and second flat display areas DA1 and DA2, the first and second folding peripheral areas, and the folding area FOU to distinguish them from one another. Then, the main driver 400 corrects the image data (e.g., at least every frame) based on the structural deformation, such as a crease in the folding area FOU and the first and second folding peripheral areas. The main driver 400 aligns the corrected image data (hereinafter referred to as corrected image data) for at least each horizontal line or frame, and provides the aligned, corrected image data to the data driver 200.

The data drivers 200 may convert the corrected image data into analog data signals at least every horizontal line in response to the data control signal from the main driver 400, and may provide the data converted data signals to the pixels. At this time, the data drivers 200 may provide the data signals to the data lines connected to the pixels at least every horizontal line.

In addition, the main driver 400 may provide supply voltages to power lines of the display DU, and may also provide gate control signals to a separate gate driver, etc. Then, the main driver 400 may receive touch data from the touch driver 500 to determine the user's touch coordinates, and then may generate digital video data based on the touch coordinates. In addition, the main driver 400 may run an application indicated by an icon displayed on the user's touch coordinates. For another example, the main driver 400 may receive coordinate data from an electronic pen to determine the touch coordinates of the electronic pen, and then may generate digital video data according to the touch coordinates or may run an application indicated by an icon displayed at the touch coordinates of the electronic pen.

FIG. 4 is a view showing an example of a layout of a display panel according to one or more embodiments of the present disclosure. For example, FIG. 4 is a view showing a layout of a part of the display area DA and the non-display area NDA of the display DU before the touch sensor TSU is formed.

The display area DA may be defined as the (generally) central area including the center of the display panel 100. For example, the display area DA may include a plurality of pixels SP, a plurality of gate lines GL, a plurality of data lines DL, a plurality of voltage lines VL, etc. Each of the plurality of pixels SP may be defined as the minimum unit that outputs red light, green light, blue light, white light, etc.

The plurality of gate lines GL may provide the gate signals received from at least one gate driver 210 to the plurality of pixels SP. The plurality of gate lines GL may extend in the first direction (x-axis direction), and may be spaced apart from each other in the second direction (y-axis direction) crossing the first direction (x-axis direction).

The plurality of data lines DL may provide the data voltages received from the data driver 200 to the plurality of pixels SP. The plurality of data lines DL may extend in the second direction (y-axis direction), and may be spaced apart from each other in the first direction (x-axis direction).

The plurality of voltage lines VL may apply the supply voltage received from the main driver 400 or a separate power supply to the plurality of pixels SP. The supply voltage may be at least one of a driving voltage, an initialization voltage, or a reference voltage. The plurality of voltage lines VL may extend in the second direction (y-axis direction), and may be spaced apart from each other in the first direction (x-axis direction).

The non-display area NDA is a peripheral area surrounding the display area DA, and may ultimately be defined as a bezel area. The non-display area NDA may include the gate driver 210, fan-out lines FOL, and gate control lines GCL. The gate driver 210 may generate a plurality of gate signals based on the gate control signal, and may sequentially supply the plurality of gate signals to the plurality of gate lines GL in a corresponding order.

The fan-out lines FOL may extend from the data driver 200 to the image display area DA. The fan-out lines FOL may supply the data voltage received from the data driver 200 to the plurality of data lines DL.

The gate control line GCL may extend from the main driver 400 to the gate driver 210. The gate control line GCL may supply the gate control signal received from the main driver 400 to the gate driver 210.

The data driver 200 may provide data voltages to the data lines DL through the fan-out lines FOL. The data voltages may be applied to the plurality of pixels SP, so that the display luminance of the plurality of pixels SP may be determined. On the other hand, the main driver 400 may supply a gate control signal to the gate driver 210 through the gate control line GCL.

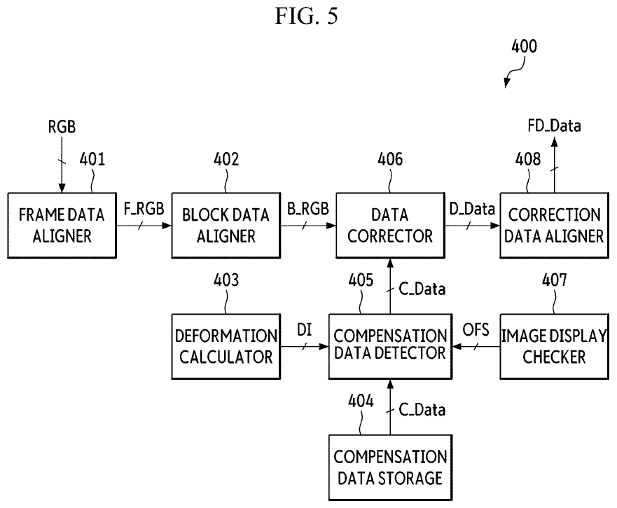

FIG. 5 is a block diagram showing in detail a main driver according to first one or more embodiments.

The main driver 400 shown in FIG. 5 includes a frame data aligner 401, a block data aligner 402, a deformation calculator 403, a compensation data storage 404, a compensation data detector 405, a data corrector 406, an image display checker 407, and a correction data aligner 408.

The data aligner 401 aligns image data RGB input from an external source, such as a graphics card or graphics system, (e.g., at least every frame), and sequentially provides the image data F_RGB to the block data aligner 402.

The block data aligner 402 divides the display area DA of the display panel 100 into at least one folding area FOU, a plurality of folding peripheral areas, and a plurality of flat display areas DA1 and DA2 according to area information (e.g., (predetermined area information). Then, the block data aligner 402 divides and aligns image data F_RGB (e.g., at least every frame) into block data B_RGB according to the previously divided areas.

For example, the block data aligner 402 may divide and align the image data F_RGB (e.g., at least every frame) into block data B_RGB corresponding to each of the at least one folding area FOU, the folding peripheral areas, and the flat display areas DA1 and DA2.

FIG. 6 is a view showing a folding area, folding peripheral areas, and flat display areas divided in a display area according to one or more embodiments of the present disclosure.

Referring to FIG. 6, the display area DA of the display device 10 may be divided in advance into at least one folding area FOU, the first and second folding peripheral areas COU1 and COU2, which are peripheral areas of the folding area FOU, and the first and second flat display areas DA1 and DA2.

For example, the folding area FOU may be located between the first and second flat display areas DA1 and DA2. the first folding peripheral area COU1 may be located between the side of the folding area FOU and the first flat display area DA1, and the second folding peripheral area COU2 may be located between the other side of the folding area FOU and the second flat display area DA2.

The at least one folding area FOU may extend in the second direction (e.g., y-axis direction in FIG. 1) between the first and second flat display areas DA1 and DA2 and between first and second folding peripheral areas COU1 and COU2, and may be folded inwardly or outwardly along the first direction (e.g., x-axis direction in FIG. 1). For example, the folding area FOU may be located between the first and second folding peripheral areas COU1 and COU2. The first and second folding peripheral areas COU1 and COU2 may be respectively located on the first and second sides of the folding area FOU.

The first flat display area DA1 may be located on one side of the folding area FOU and the first folding peripheral area COU1, for example, on the right side of the first folding peripheral area COU1. The second flat display area DA2 may be located on the opposite side of the folding area FOU and the second folding peripheral area COU2, for example, on the left side of the second folding peripheral area COU2.

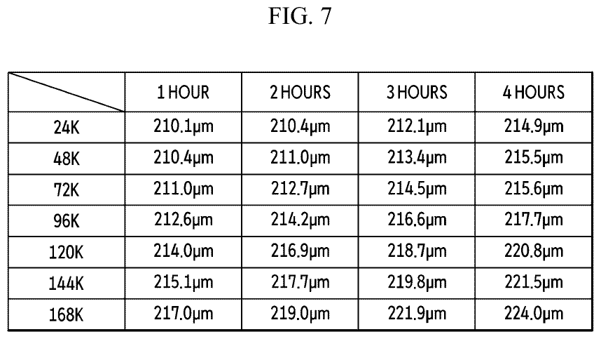

FIG. 7 is a view showing experimental values of crease deformation in the folding area over the number of folding times and folding duration.

Referring to FIGS. 5, 6, and 7, the deformation calculator 403 counts the number of folding times and folding duration (e.g., total folding duration) in real time to calculate structural deformation amount information (e.g., information corresponding to an amount or degree of structural deformation) DI for at least one folding area FOU and the folding peripheral areas COU1 and COU2.

The deformation calculator 403 counts the number of folding times and the folding duration in real time, and calculates the structural deformation amount information DI of the folding area FOU corresponding to each of the counted number of folding times and the folding duration. The structural deformation amount information DI of the folding area FOU (e.g., the structural deformation amount information DI corresponding to each of the number of folding times and the folding duration of the folding area FOU) may be determined (e.g., predetermined) based on experimental values. The structural deformation amount information DI of the folding area FOU may include, for example, thickness change information of the folding area FOU, deformation size information, or thickness information of a crease shape.

Likewise, the structural deformation amount information DI corresponding to each of the number of folding times and folding duration of the first and second folding peripheral areas COU1 and COU2 may also be determined (e.g., predetermined) based on the experimental values. Accordingly, the deformation calculator 403 calculates the structural deformation amount information DI corresponding to each of the counted number of folding times and the folding duration for the folding area FOU and the first and second folding peripheral areas COU1 and COU2, and transmits the information to the compensation data detector 405.

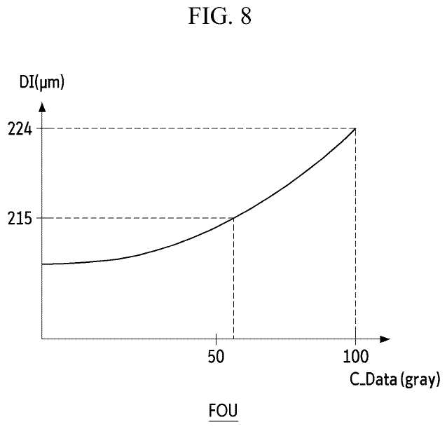

FIG. 8 is a graph showing change in the grayscale value of corrected data applied to image data of the folding area versus the amount of crease deformation in the folding area.

Referring to FIGS. 5 and 8, the compensation data storage 404 stores compensation data (e.g., predetermined compensation data) C_Data according to the structural deformation amount for each of the at least one folding area FOU and the folding peripheral areas COU1 and COU2.

For example, the compensation data C_Data may be determined for each of the folding area FOU, the first and second folding peripheral area COU1 and COU2, and the first and second flat display areas DA1 and DA2, so that the compensation data C_Data corresponds to the structural deformation amount information DI for each of the folding area FOU and the first and second folding peripheral areas COU1 and COU2.

The compensation data C_Data includes compensation grayscale values or compensation luminance values of image data for each of the folding area FOU, the first and second folding peripheral areas COU1 and COU2, and the first and second flat display areas DA1 and DA2.

The grayscale values or luminance values included in the compensation data C_Data for each of the folding area FOU, the first and second folding peripheral areas COU1 and COU2, and the first and second flat display areas DA1 and DA2 may be determined (e.g., predetermined) and stored in a gradually variable form that is proportional to the structural deformation amount of the folding area FOU.

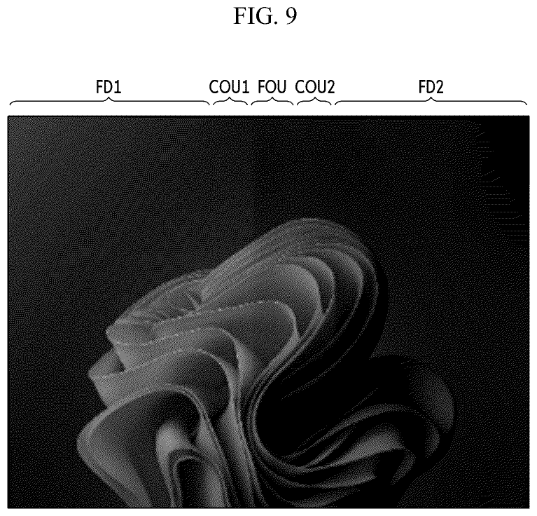

FIG. 9 is a view showing an example in which an image is displayed in the folding area, the folding peripheral areas, and the flat display areas in the flat state.

Referring to FIGS. 5 and 9, the image display checker 407 checks whether or not the image is displayed in the folding state, and transmits an image display signal or an image non-display signal OFS to the compensation data detector 405.

If the image is displayed in the folding state, the image display checker 407 transmits an image display signal to the compensation data detector 405.

If the image is displayed in the folding state, the compensation data detector 405 detects compensation data C_Data for each of at least one folding area FOU and the folding peripheral areas COU1 and COU2 based on the structural deformation amount information DI calculated in real time by the deformation calculator 403. Then, the compensation data detector 405 provides the compensation data C_Data for each of the folding area FOU and the folding peripheral areas COU1 and COU2 corresponding to the structural deformation amount information DI to the data corrector 406.

The data corrector 406 calculates, using a calculation formula (e.g., predetermined calculation formula), the block data B_RGB according to at least one folding area FOU, the folding peripheral areas COU1 and COU2, and the flat display areas DA1 and DA2 with the compensation data C_Data for each of the areas detected by the compensation data detector 405, to generate compensation image data D_Data for each of the block areas.

For example, if the image is not displayed in the folding state, the data corrector 406 receives the compensation data C_Data for each of the folding area FOU and the folding peripheral areas COU1 and COU2 through the compensation data detector 405. Then, the data corrector 406 calculates the block data B_RGB for each of the folding area FOU and the folding peripheral areas COU1 and COU2 with the compensation data C_Data for each of the folding area FOU and the folding peripheral areas COU1 and COU2 using the calculation formula, such as addition/subtraction, multiplication, and division, to generate the correction image data D_Data for each of the folding area FOU and the folding peripheral areas COU1 and COU2.

The main driver 400 includes the correction data aligner 408 that combines the corrected image data D_Data for each block area according to each block area to generate and to output the corrected image data FD_Data (e.g., at least every frame).

For example, the correction data aligner 408 combines the corrected image data D_Data for each of the folding area FOU and the folding peripheral areas COU1 and COU2 with the block data B_RGB for the flat display areas DA1 and DA2 to generate and to output the corrected image data FD_Data.

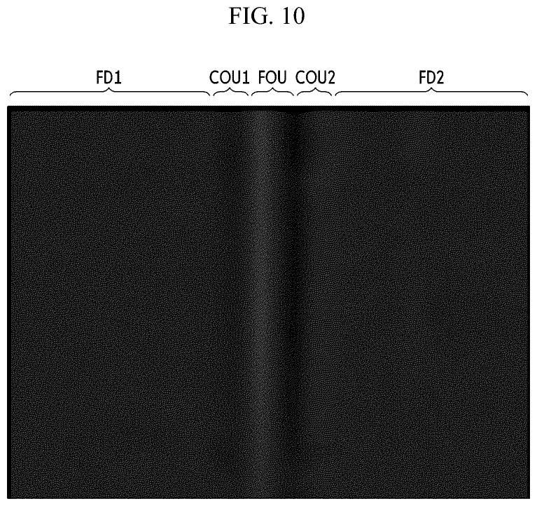

FIG. 10 is a view showing an example in which an image is not displayed in the folding area, the folding peripheral areas, and the flat display areas in the flat state.

If the image is not displayed in the folding state (e.g., if the screen is turned off), the image display checker 407 transmits an image non-display signal OFS to the compensation data detector 405.

If an image is not displayed in the folding state, the compensation data detector 405 detects compensation data C_Data for each of the flat display areas DA1 and DA2 based on the structural deformation amount information DI calculated in real time by the deformation calculator 403. Then, the compensation data detector 405 provides the compensation data C_Data for each of the flat display areas DA1 and DA2 corresponding to the structural deformation amount information DI to the data corrector 406.

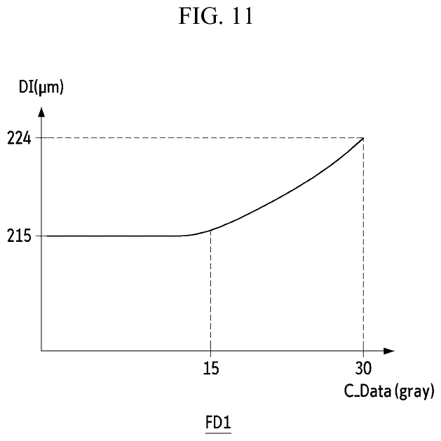

FIG. 11 is a graph showing change in the grayscale value of corrected data applied to image data of a flat display area versus the amount of crease deformation in the folding area.

Referring to FIG. 11, the compensation data C_Data for the flat display areas DA1 and DA2 correspond to the structural deformation amount information DI of the folding area FOU.

The compensation data C_Data for the flat display areas DA1 and DA2 include compensation grayscale values or compensation luminance values of the image data for each of the flat display areas DA1 and DA2.

For example, the grayscale values or luminance values included in the compensation data C_Data for each of the flat display areas DA1 and DA2 may be determined (e.g., predetermined) and stored in a variable form in proportion to the structural deformation amount of the folding area FOU.

If the image is not displayed in the folding state, the data corrector 406 receives the compensation data C_Data for the flat display areas DA1 and DA2 through the compensation data detector 405. Then, the data corrector 406 calculates, using the calculation formula, the block data B_RGB for each of the flat display areas DA1 and DA2, and the compensation data C_Data for each of the flat display areas DA1 and DA2, to generate corrected image data D_Data for each of the flat display areas DA1 and DA2.

The correction data aligner 408 combines the corrected image data D_Data for each of the flat display areas DA1 and DA2 with the block data B_RGB for each of the folding area FOU and the folding peripheral areas COU1 and COU2, to generate and to output the corrected image data FD_Data.

If an image is displayed in the folding state, the brightness or luminance of the low-gray image displayed in the flat display areas DA1 and DA2 may be corrected to become higher than the folding area FOU and the folding peripheral areas COU1 and COU2.

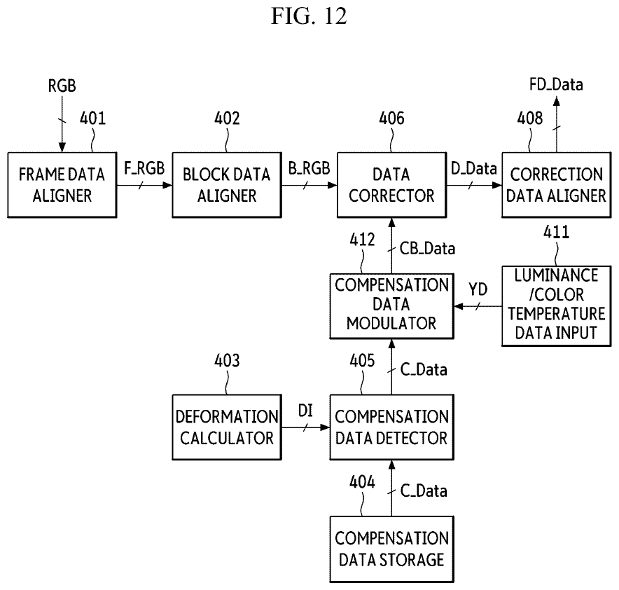

FIG. 12 is a block diagram showing in detail a main driver according to second one or more embodiments.

Referring to FIG. 12, the main driver 400 further includes a luminance/color temperature data input 411 and a compensation data modulator 412.

The luminance/color temperature data input 411 detects ambient luminance information or color temperature information of the display panel 100 using a luminance sensor formed on the display panel 100. Then, the luminance/color temperature data input 411 generates luminance data YD or color temperature data corresponding to the ambient luminance information or color temperature information, and provides luminance data YD or the color temperature data to the compensation data modulator 412.

The compensation data modulator 412 extracts an offset value that is inversely proportional to the luminance information or color temperature information of the luminance data YD or color temperature data, and modulates the compensation data C_Data detected by the compensation data detector 405 using the offset value.

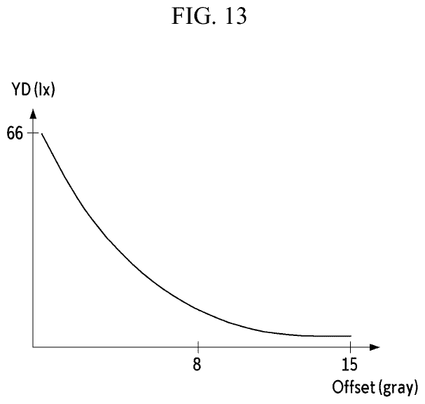

FIG. 13 is a graph showing change in the offset value applied to the compensation data versus change in external luminance or color temperature.

Referring to FIGS. 12 and 13, the compensation data modulator 412 may extract an offset value Offset that is inversely proportional to the luminance information of luminance data YD.

The compensation data modulator 412 calculates the compensation data C_Data detected in the data detector 405 with the offset value Offset extracted in real time using the calculation formula, such as addition/subtraction, multiplication, and division, to modulate the compensation data C_Data.

The data corrector 406 performs a calculation using the compensation data CB_Data modulated by the compensation data modulator 412 with the block data B_RGB for each of the folding area FOU and the folding peripheral areas COU1 and COU2 or with the block data B_RGB according to the flat display area DA1 and DA2, depending on whether or not an image is displayed in the folding state. By doing so, it is possible to vary the brightness or luminance of the image displayed in the folding area FOU, the folding peripheral areas COU1 and COU2 or the flat display areas DA1 and DA2 based on the ambient luminance information or color temperature information of the display panel 100.

In concluding the detailed description, those skilled in the art will appreciate that many variations and modifications can be made to the embodiments without substantially departing from the principles of the present disclosure. Therefore, the disclosed embodiments of the disclosure are used in a generic and descriptive sense only and not for purposes of limitation.

What is claimed is:

1. A display device comprising:
a display panel comprising pixels in a display area having a folding area;
a data driver configured to provide data signals to the pixels; and
a main driver configured to:
correct image data based on a structural deformation amount of the folding area;
provide the corrected image data to the data driver;
control driving timing of the data driver;
divide the display area into the folding area, a first flat display area, and a second flat display area;
align the image data; and
provide the image data to the data driver.

2. The display device of claim 1, wherein the main driver is further configured to:
divide the display area into the folding area, a first folding peripheral area, a second folding peripheral area, the first flat display area, and the second flat display area; and
generate the corrected image data by correcting the image data corresponding to at least one of the folding area, the first folding peripheral area, the second folding peripheral area, the first flat display area, or the second flat display area based on the structural deformation amount of the folding area, the first folding peripheral area, or the second folding peripheral area.

3. The display device of claim 1, wherein the main driver comprises:
a block data aligner configured to divide the display area into the folding area, the first folding peripheral area, the second folding peripheral area, the first flat display area, and the second flat display area, and configured to divide and align the corrected image data at least every frame into block data;
a deformation calculator configured to count a number of folding times and folding duration of the display panel, and configured to calculate structural deformation amount information for the folding area, the first folding peripheral area, or the second folding peripheral area;
a compensation data detector configured to detect compensation data corresponding to the structural deformation amount information; and
a data corrector configured to calculate, using a calculation formula, the block data according to the folding area, the first folding peripheral area, the second folding peripheral area, the first flat display area, and the second flat display area with the compensation data, and configured to generate the image data.

4. The display device of claim 3, wherein the main driver further comprises:
a frame data aligner configured to align the image data at least every frame, and configured to provide the image data to the block data aligner;
a compensation data storage configured to store the compensation data according to the structural deformation amount as one or more experimental values;
an image display checker configured to check whether an image is displayed in a folding state, and configured to output an image display signal or an image non-display signal; and
a correction data aligner configured to combine the corrected image data to generate, and configured to output the corrected image data at least every frame.

5. The display device of claim 3, wherein the block data aligner is configured to divide the display area into the folding area, the first folding peripheral area, the second folding peripheral area, the first flat display area, and the second flat display area, according to area information.

6. The display device of claim 5, wherein the deformation calculator is configured to count the number of the folding times and the folding duration, is configured to calculate the structural deformation amount information based on the number of the folding times and the folding duration, and is configured to provide the structural deformation amount information to the compensation data detector.

7. The display device of claim 5, wherein the compensation data corresponds to the structural deformation amount information, and
wherein the compensation data comprises compensation grayscale values or compensation luminance values for the folding area, the first folding peripheral area, the second folding peripheral area, the first flat display area, or the second flat display area.

8. The display device of claim 7, wherein the compensation grayscale values or the compensation luminance values are stored in a gradually variable form proportional to the structural deformation amount.

9. The display device of claim 5, wherein, when an image is displayed in a folding state of the display panel, the compensation data detector is configured to detect the compensation data according to the structural deformation amount information calculated by the deformation calculator, and is configured to provide the compensation data to the data corrector, and
wherein the data corrector is configured to calculate the compensation data with the block data using the calculation formula, and is configured to generate the corrected image data.

10. The display device of claim 5, wherein, when an image is not displayed in a folding state of the display panel, the compensation data detector is configured to detect the compensation data according to the structural deformation amount information calculated by the deformation calculator, and is configured to provide the compensation data to the data corrector, and
wherein the data corrector is configured to calculate the block data with the compensation data using the calculation formula, and is configured to generate the corrected image data.

11. The display device of claim 3, wherein the main driver further comprises:
a luminance/color temperature data input configured to detect luminance information or color temperature information of the display panel using a luminance sensor, and is configured to generate luminance data or color temperature data corresponding to the luminance information or the color temperature information; and
a compensation data modulator configured to extract an offset value inversely proportional to the luminance information or the color temperature information, and configured to modulate the compensation data using the offset value.

12. The display device of claim 11, wherein the compensation data modulator is configured to extract the offset value that is inversely proportional to the luminance information, and is configured to modulate the compensation data by calculating the compensation data with the offset value using a calculation formula.

13. The display device of claim 12, wherein, when an image is displayed in a folding state of the display panel, the compensation data modulator is configured to calculate the compensation data modulated by the compensation data modulator with the block data by the calculation formula, and
wherein, when no image is displayed in the folding state of the display panel, the compensation data modulator is configured to calculate the modulated compensation data with the block data using the calculation formula.

14. A display device comprising:
a display panel comprising pixels in a display area having a folding area;
a data driver configured to provide data signals to the pixels;
a gate driver configured to provide gate signals to the pixels;
a touch sensor on a front surface of the display panel for detecting a user touch;
a touch driver configured to detect a touch position and a touch movement position for a touch-sensing area of the touch sensor, and configured to generate touch coordinate data; and
a main driver configured to:
control driving timing of the data driver;
divide the display area into the folding area, a first folding peripheral area, a second folding peripheral area, a first flat display area, and a second flat display area;
generate corrected image data by correcting externally supplied image data corresponding to at least one of the folding area, the first folding peripheral area, the second folding peripheral area, the first flat display area, or the second flat display area according to a structural deformation amount of the folding area, the first folding peripheral area, or the second folding peripheral area; and
provide the corrected image data to the data driver.

15. The display device of claim 14, wherein the main driver comprises:
a block data aligner configured to divide the image data at least every frame into block data according to the folding area, the first folding peripheral area, the second folding peripheral area, the first flat display area, and the second flat display area to align the block data;
a deformation calculator configured to count a number of folding times and folding duration of the display panel, and configured to calculate structural deformation amount information for the folding area, the first folding peripheral area, and the second folding peripheral area;
a compensation data detector configured to detect compensation data corresponding to the structural deformation amount information; and
a data corrector configured to calculate, using a calculation formula, the block data with the compensation data to generate the corrected image data.

16. An electronic device comprising a display device, the display device comprising:
a display panel comprising pixels in a display area having a folding area;
a data driver configured to provide data signals to the pixels; and
a main driver configured to:
correct image data based on a structural deformation amount of the folding area;
provide the corrected image data to the data driver;
control driving timing of the data driver;
divide the display area into the folding area, a first flat display area, and a second flat display area;
align the image data; and
provide the image data to the data driver.
